(19) United States
(12) Patent Application Publication
(10) Pub. No.: US 2002/0195525 A1
(43) Pub. Date: Dec. 26, 2002

(54) Spray on-foam insulation system for an aircraft

(76) Inventors: Claire E. Anton, Los Alamitos, CA (US); Trent R. Logan, Foothill Ranch, CA (US); Sheryl A. DeCillis, Cypress, CA (US)

Correspondence Address: HARNESS, DICKEY & PIERCE, P.L.C., P.O. BOX 828, BLOOMFIELD HILLS, MI, 48303, US

(21) Appl. No.: 09/886,929

(22) Filed: Jun. 21, 2001

(51) Int. Cl. B64C 1/00

(52) U.S. Cl. 244/129.1

(57) ABSTRACT

A sprayed on, semi-rigid, substantially closed cell foam insulation which forms an insulative layer directly on an interior wall or internal structural member associated with a skin of an aircraft fuselage. The foam insulation may comprise a polyurethane, substantially closed cell foam which is sprayed on to the interior wall of the fuselage to form a layer having a thickness of between about 0.25 inch-1.5 inch and a weight of between about 2 lbs. per cubic foot to about 3 lbs per cubic foot. The insulative layer forms a thermal and acoustic barrier and is highly resistant to the absorption of condensation and humidity. The foam insulation, being sprayed on, can be installed much more quickly than conventional blanket-type insulation material and with significantly less cost.

### FIELD OF THE INVENTION

This invention relates to insulation systems for aircraft, and more particularly to a sprayed on foam insulation layer which is applied directly to an interior wall surface of a skin or any internal structural members of an aircraft.

### BACKGROUND OF THE INVENTION

Present day aircraft typically experience large temperature differentials between the inside and the outside of the fuselage thereof during flight that requires the employment of insulation to moderate the interior temperature of the aircraft. A difficult challenge is created by exterior temperatures that are below those desired within the fuselage. A commercial airliner at cruising altitude experiences exterior temperatures significantly below freezing. The passengers and crew of the aircraft also produce significant levels of humidity within the fuselage. This water vapor tends to condense on cold surfaces presented either on the interior cabin wall, within the insulation in the space between the interior cabin wall and the exterior skin of the aircraft, or on the inside of the exterior skin. This condensation is particularly detrimental because it can result in corrosion of the skin and the various structural members attached to the skin, thus requiring additional maintenance and cost to maintain the aircraft.

The condensation problem is especially exacerbated by most present day insulation systems which involve the use of thermal insulation filler or batting material encased in a cover. The batting material is manufactured by cutting batting material into precise dimensions enabling it to be disposed at specific areas of the aircraft. This form of insulation also requires a great deal of time to install in the aircraft. When the condensation is absorbed by the batting material, this significantly increases the weight of the insulation and decreases its thermal insulation properties. This increased weight can be significant and represents an additional load that the aircraft must carry during flight. Still further, vermin and insects can also be harbored in the batting material used in insulating present day aircraft, thus posing a health concern.

It is therefore a principal object of the present invention to provide an insulation system for an aircraft which does not make use of conventional filler or batting material, but rather which provides an insulative layer along the inside surface or any internal structural members of a skin of an aircraft which entirely or substantially eliminates the absorption of condensation into the insulative layer.

Still another object of the present invention is to provide an insulative system for an aircraft which can be installed more quickly than conventional blanket-type insulation materials and which is less costly to manufacture than blanket-type insulation materials.

It is yet another object of the present invention to provide an insulation system for an aircraft which can be sprayed directly onto the interior wall of a skin or any internal structural members of an aircraft via a conventional spray gun to thus allow insulation to be installed much more quickly and cost effectively than conventional blanket-type insulation systems.

### SUMMARY OF THE INVENTION

The above and other objects are provided by an insulation system in accordance with a preferred embodiment of the present invention. The insulation system comprises a semi-rigid, substantially closed cell foam which is applied via a conventional spray gun directly to the inside wall of a skin of an aircraft fuselage or over any internal structural member(s) of an aircraft. The semi-rigid, substantially closed cell foam insulation forms an insulative layer which is secured directly to the interior wall of the skin or internal structural member of the aircraft. Accordingly, the insulative layer of the present invention can be installed much more quickly than conventional blanket-type insulation material, which must be cut into precise dimensions before being installed. Once installed, the insulative layer forms an entirely or substantially moisture resistant area which prevents condensation from reaching the interior wall of the skin or the surface of the structural member.

In one preferred form, the semi-rigid, substantially closed cell foam comprises a polyurethane foam. The insulative layer may vary significantly in thickness and weight, but in one preferred form comprises a weight of at least about two pounds per cubic foot and a thickness of at least about 0.25 inch (6.35 mm). The insulative layer of the present invention is also highly fire retardant and resistant to vermin and other insects and will not support fungal or microbial growths.

The insulative layer of the present invention thus forms a more lightweight, less costly insulating layer than previously used blanket-type insulation material. The sprayed on foam insulation of the present invention can be readily removed via a pressurized medium (for example, dry ice blasting). The ability of the insulative layer to resist absorbing condensation as well as humidity also ensures that the weight of the insulative layer will not increase significantly over an extended period of time, as would be the case with conventional blanket-type insulation material.

### BRIEF DESCRIPTION OF THE DRAWINGS

The present invention will become more fully understood from the detailed description and the accompanying drawings, wherein:

FIG. 1 is a perspective view of a portion of an interior wall of a cabin area of an aircraft illustrating the semi-rigid, substantially closed cell foam of the present invention being sprayed on to the interior wall to form an insulative layer thereon; and

FIG. 2 is a view of an internal structural member of the aircraft illustrating how the insulative layer completely encapsulates a bulkhead secured to the aircraft.

### DETAILED DESCRIPTION OF THE PREFERRED EMBODIMENTS

The following description of the preferred embodiments is merely exemplary in nature and is in no way intended to limit the invention, its application, or uses.

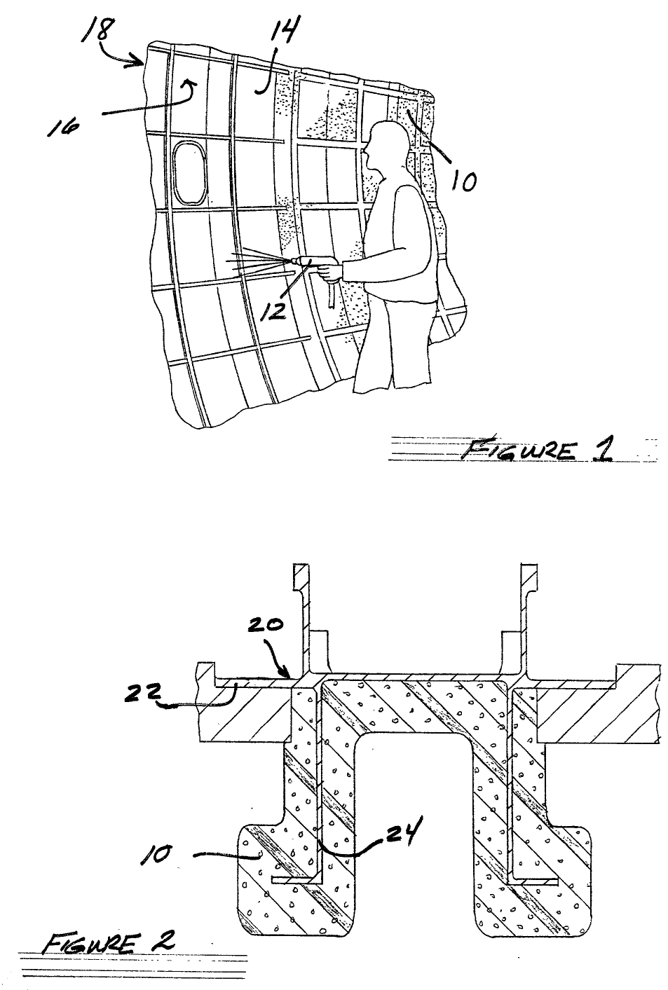

Referring to FIG. 1, there is shown a semi-rigid, substantially closed cell foam insulative layer 10 being applied by an individual via a spray gun 12. The foam insulation 10 forms an insulative layer which is applied directly against an interior surface 14 of a skin 16 of an aircraft fuselage 18. The insulative layer formed is applied directly against the interior surface 14 of the aircraft's skin 16. The application of the foam insulation 10 via spray gun 12 significantly speeds the installation of the insulation 10 as compared to conventional blanket-type (i.e., batting) insulation material which must be carefully precut to desired dimensions and then applied in a more labor intensive and time consuming process.

The foam insulation 10 of the present invention is preferably comprised of a polyurethane foam, but it will be appreciated that other forms of material could be used just as well. The important factor is that the material be capable of being applied via a spray gun, that it be substantially closed cell in structure, and that it is relatively light in weight when formed to a desired thickness. Polyurethane foam is approximately 95% closed-cell in structure and therefore forms an ideal material for forming the insulative layer.

The foam insulation 10 of the present invention is applied so as to form a thickness of preferably between about 0.25 inch-1.5 inch (6.35 mm-38.1 mm). The insulation 10 further has a weight of preferably between about 2 pounds per cubic foot to 3 pounds per cubic foot. Once applied, the foam insulation 10 can be removed by a blast removal process, such as with pressurized dry ice and a vacuum collector.

Referring to FIG. 2, a small cross section of an internal structural member 20 is illustrated with the foam insulation 10 of the present invention having been applied thereto. Once the foam insulation 10 is applied, it substantially encases not only a flange 22 of the structural member 20 but it also fully encapsulates any frame components, such as bulkhead 24, which may be attached to an interior wall or other aircraft structure adjacent the interior wall.

It is a principal advantage of the present invention that the foam insulation 10 forms an excellent acoustic and thermal insulative barrier on the inside portion 14 or internal structural member 20 while being highly resistant to the absorption of moisture and humidity which plagues conventional blanket-type insulation materials. Thus, the foam insulation 10 of the present invention will maintain its relatively light weight over long periods of time, whereas conventional blanket-type insulation systems will be susceptible to gaining significant weight as the blanket-type insulation absorbs condensation and humidity. The foam insulation 10 is sufficiently flexible to maintain adherence to the aircraft skin 16 or structural member 20 as the aircraft is pressurized and depressurized many hundreds or thousands of time over the life of the aircraft. The foam insulation 10 can be washed using conventional non-solvent based cleaning fluids without incurring damage or absorbing moisture. The foam insulation 10 is further highly resistant to sustaining or propagating a flame for environments below about 650° F.

Those skilled in the art can now appreciate from the foregoing description that the broad teachings of the present invention can be implemented in a variety of forms. It will also be appreciated that the variations of the preferred embodiments in specific embodiments herein could readily be implemented in other ones of the embodiments. Therefore, while this invention has been described in connection with particular examples thereof, the true scope of the invention should not be so limited since other modifications will become apparent to the skilled practitioner upon a study of the drawings, specification and following claims.

What is claimed is:

1. An insulation system for insulating at least a portion of a structural component of an aircraft, comprising:
a semi-rigid substantially closed cell foam which is sprayed directly onto said structural component to thereby form an insulative layer, and still permit subsequent removal of said insulative layer for inspection purposes.

2. The insulation system of claim 1, wherein said semi-rigid, substantially closed cell foam comprises a polyurethane foam.

3. The insulation system of claim 1, wherein said semi-rigid, substantially closed cell foam comprises a weight of at least about two pounds per cubic foot.

4. The insulation system of claim 1, wherein said semi-rigid, substantially closed cell foam comprises a weight of between about two to three pounds per cubic foot.

5. The insulation system of claim 1, wherein said insulative layer comprises a thickness of at least about 0.25 inch (6.35 mm).

6. The insulation system of claim 1, wherein said insulative layer comprises a thickness of between about 0.25 inch-1.5 inch (6.35 mm-38.1 mm).

7. The insulation system of claim 1, wherein said semi-rigid, substantially closed cell foam is sprayed onto said structural component so as to encapsulate frame components secured to said structural component.

8. An insulation system for insulating an interior wall of a skin of an aircraft or an internal structural member comprising:
a semi-rigid, substantially closed cell foam sprayed directly onto said interior wall or onto said internal structural member to thereby form an insulative layer directly thereon;
wherein said insulative layer can be removed thereafter for inspection; and
wherein said insulative layer comprises a thickness of at least about 0.25 inch (6.35 mm) and at least substantially encapsulates said interior wall or said internal structural member.

9. The insulation system of claim 8, wherein said insulative layer comprises a thickness between about 0.25 inch and 1.5 inch (6.35 mm-38.1 mm).

10. The insulation system of claim 8, wherein said insulative layer comprises a weight of at least about two pounds per cubic foot.

11. The insulation system of claim 8, wherein said insulative layer comprises a weight of between two and three pounds per cubic foot.

12. The insulation system of claim 8, wherein said semi-rigid, substantially closed cell foam is sprayed onto said interior wall so as to encapsulate frame components secured to said interior wall.

13. An insulation system for insulating a structural member associated with a skin of an aircraft, or an internal wall of the skin, comprising:
a semi-rigid, substantially closed cell foam sprayed directly onto said structural member or onto said internal wall to thereby form an insulative layer directly on said structural member or said internal wall which encapsulates frame components secured to or disposed against said internal wall or said structural member;
wherein said insulative layer can be removed thereafter for inspection;
wherein said insulative layer comprises a weight of between about 2.0-3.0 pounds per cubic foot; and
wherein said insulative layer comprises a thickness of at least about 0.25 inch (6.35 mm).

14. The insulation system of claim 13, wherein said insulative layer comprises a thickness of between about 0.25 inch to about 1.5 inch (6.35 mm-38.1 mm)

15. The insulation system of claim 13, wherein said semi-rigid, substantially closed cell foam comprises a polyurethane foam.
